(19) United States
(12) Patent Application Publication
(10) Pub. No.: US 2026/0330041 A1
(43) Pub. Date: Oct. 22, 2026

(54) Techniques for Improved File Sharing Through Link-Based Collaboration and Granular Access Control

(71) Applicant: MCKINSEY & COMPANY, INC., New York, NY (US)

(72) Inventors: Jaymin Jagmohan, Waldwick, NJ (US); Ashok Munisamy, Somerset, NJ (US); Srikanth Jayarajan, Franklin Park, NJ (US); Santhosh Xavier, Robbinsville, NJ (US)

(21) Appl. No.: 19/185,672

(22) Filed: Apr. 22, 2025

(51) Int. Cl. G06F 21/60; G06F 21/31; G06F 21/62

(52) U.S. Cl. CPC G06F 21/604; G06F 21/31; G06F 21/6209

(57) ABSTRACT

Systems and methods for secure file sharing and collaboration are disclosed. An example method includes receiving a first indication to securely distribute a portion of a file with one or more collaborators, generating based on the first indication, a secure access point for the one or more collaborators to change a copy of the portion of the file. The method may receive a second indication to merge one or more changes made by the one or more collaborators to the copy of the portion of the file through the secure access point and update the file to incorporate the one or more changes into the file. The method may additionally include methods for access control and collaborator authentication to improve the security of data contained in the shared portion of the file.

### FIELD OF THE DISCLOSURE

The present disclosure generally relates to secure access control when sharing a file, and more particularly, to systems and methods for improved file sharing through link-based collaboration that improves the efficiency and security of sharing files.

### BACKGROUND

Within an organization, members often need to share files with other members of the organization such that the other members can make changes to the shared files. However, many conventional file sharing methods are insecure and lack an efficient method of sharing a portion of a file. The security risks and inefficiencies of conventional methods are only compounded when a file needs to be shared with multiple collaborators and/or when an organization has many members sharing many files. Collaboration between/among multiple organization members working on a single file is incredibly prevalent, and increasing with time, meaning these failures of conventional techniques will likely lead to even greater risks and inefficiencies as such collaboration continues to grow in scale.

### SUMMARY

In some aspects, the techniques described herein relate to a computer-implemented method, including: a computer-implemented method for secure file distribution and collaboration, the computer-implemented method comprising: receiving, by one or more processors, a first indication to securely distribute a portion of a file with one or more collaborators; generating, by the one or more processors and based on the first indication, a secure access point for the one or more collaborators to change a copy of the portion of the file; distributing, by the one or more processors, the secure access point to the one or more collaborators; receiving, by the one or more processors, a second indication to merge one or more changes to the copy of the portion of the file made by at least one of the one or more collaborators through the secure access point; and updating, by the one or more processors and in response to the second indication, the portion of the file to incorporate the one or more changes made to the copy of the portion of the file.

In some aspects, the techniques described herein relate to a computer-implemented method, wherein generating the secure access point further comprises: generating, by the one or more processors, a key identifying a location of the portion of the file within the file; extracting, by the one or more processors, the portion of the file from the file based on the location identified by the generated key; and transmitting, by the one or more processors, the portion of the file to the secure access point.

In some aspects, the techniques described herein relate to a computer-implemented method, wherein updating the portion of the file to incorporate the one or more changes to the copy of the portion of the file further comprises: receiving, by the one or more processors, the copy of the portion of the file from the secure access point; merging, by the one or more processors, the copy of the portion of the file into the file based on the location identified by the generated key; and deleting, by the one or more processors, the copy of the portion of the file from the secure access point.

In some aspects, the techniques described herein relate to a computer-implemented method, further comprising: authenticating, by the one or more processors, a collaborator of the one or more collaborators in response to the collaborator attempting to change the copy of the portion of the file through the secure access point; and blocking, by the one or more processors, access to change the copy of the portion of the file for the collaborator in response to a failed authentication.

In some aspects, the techniques described herein relate to a computer-implemented method, in response to a successful authentication, further comprising: determining, by the one or more processors, if the collaborator has permission to change the copy of the portion of the file via the secure access point; transmitting, by the one or more processors, a security token to the collaborator in response to a successful determination wherein the security token is required to change the copy of the portion of the file; and blocking, by the one or more processors, access to change to the copy of the portion of the file through the secure access point in response to a failed determination.

In some aspects, the techniques described herein relate to a computer-implemented method, further comprising: in response to a pre-determined number of failed authentication attempts, blocking, by the one or more processor, access to the secure access point for the collaborator.

In some aspects, the techniques described herein relate to a computer-implemented method, further comprising: blocking, by the one or more processors, access to change the copy of the portion of the file for the one or more collaborators after a predetermined amount of time; or blocking, by the one or more processors, access to change the copy of the portion of the file for the one or more collaborators after a time limit indicated in the first indication.

In some aspects, the techniques described herein relate to a computer-implemented method, further comprising: receiving, by the one or more processors, a third indication to revoke permissions to change the copy of the portion of the file for a first collaborator of the one or more collaborators; and responsive to receiving the third indication, blocking, by the one or more processors, access to change the copy of the portion of the file for the first collaborator, wherein a second collaborator of the one or more collaborators maintains access change the copy of the portion of the file.

In some aspects, the techniques described herein relate to a computer-implemented method, wherein the secure access point stores the copy of the portion of the file on a server and wherein the server is a cloud storage server.

In some aspects, the techniques described herein relate to a computer-implemented method, wherein the first indication identifies the one or more collaborators, a location of the portion of the file, and a time limit for allowing collaboration.

In some aspects, the techniques described herein relate to a computer-implemented method, wherein the secure access point blocks the one or more collaborators from downloading the copy of the portion of the file.

In some aspects, the techniques described herein relate to a computer-implemented method, wherein the secure access point is accessed via a hyperlink.

In some aspects, the techniques described herein relate to a computer-implemented method, wherein distributing the secure access point further comprises transmitting the hyperlink to the one or more collaborators via email.

In some aspects, the techniques described herein relate to a computing system include: one or more processors; and non-transitory computer memory containing computer-executable instructs that when executed by the one or more processors, cause the computing system to: receive a first indication to securely distribute a portion of a file with one or more collaborators; generate, based on the first indication, a secure access point for the one or more collaborators to change a copy of the portion of the file; distribute the secure access point to the one or more collaborators; receive a second indication to merge one or more changes to the copy of the portion of the file made by at least one of the one or more collaborators through the secure access point; and update, in response to the second indication, the portion of the file to incorporate the one or more changes made to the copy of the portion of the file.

In some aspects, the techniques described herein relate to a computing system, wherein causing the computing system to generate the secure access point further causes the computing system to: generate a key identifying a location of the portion of the file relative to the file; extract the portion of the file from the file based on the location identified by the generated key; and transmit the portion of the file to the secure access point.

In some aspects, the techniques described herein relate to a computing system, wherein causing the computing system to update the portion of the file to incorporate the one or more changes to the copy of the portion of the file further causes the computing system to: receive the copy of the portion of the file from the secure access point; merge the copy of the portion of the file into the file based on the location identified by the generated key; and delete the copy of the portion of the file from the secure access point.

In some aspects, the techniques described herein relate to a computing system wherein the non-transitory computer memory contains further computer-executable instructions that when executed by the one or more processors, further cause the computing system to: authenticate a collaborator of the one or more collaborators in response to the collaborator attempting to change the copy of the portion of the file through the secure access point; and block access to change the copy of the portion of the file for the collaborator in response to a failed authentication.

In some aspects, the techniques described herein relate to a computing system, wherein the non-transitory computer memory contains further computer-executable instructions that when executed by the one or more processors, further cause the computing system to: block access to change the copy of the portion of the file for the one or more collaborators after a predetermined amount of time; or block access to change the copy of the portion of the file for the one or more collaborators after a time limit indicated in the first indication.

In some aspects, the techniques described herein relate to a computing system, wherein the non-transitory computer memory contains further computer-executable instructions that when executed by the one or more processors, further cause the computing system to: receive a third indication to revoke permission to change the copy of the portion of the file for a first collaborator of the one or more collaborators; and responsive to receiving the third indication, block access to change the copy of the portion of the file for the first collaborator, wherein a second collaborator of the one or more collaborators maintains access to change the copy of the portion of the file.

In some aspects, the techniques described herein relate to a non-transitory computer-readable medium storing instructions that, when executed by one or more processors, cause the one or more processors to: receive a first indication to securely distribute a portion of a file with one or more collaborators; generate, based on the first indication, a secure access point for the one or more collaborators to edit a copy of the portion of the file; distribute the secure access point to the one or more collaborators; receive a second indication to merge one or more changes to the copy of the portion of the file made by at least one of the one or more collaborators through the secure access point; and update, in response to the second indication, the portion of the file to incorporate the one or more changes made to the copy of the portion of the file.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive and/or limiting.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates an example computing environment for implementing various techniques associated with secure file sharing, in accordance with various embodiments described herein.

FIG. 2 illustrates an example high-level signal diagram of a method of secure file sharing, in accordance with various embodiments described herein.

FIG. 3 illustrates an example method of distributing a secure access point for secure file sharing, in accordance with various embodiments described herein.

FIG. 4 illustrates an example method of automatically merging changes made to a file, in accordance with various embodiments described herein.

FIG. 5 illustrates an example method for secure collaborator authentication, in accordance with various embodiments described herein.

FIG. 6 illustrates an example method of controlling access to a collaborator, in accordance with various embodiments described herein.

FIG. 7 illustrates an example method for secure file sharing and collaboration, in accordance with various embodiments described herein.

The Figures depict preferred embodiments for purposes of illustration only. Alternative embodiments of the systems and methods illustrated herein may be employed without departing from the principles of the invention described herein.

### DETAILED DESCRIPTION OF THE INVENTION

The present techniques involve a computer-implemented method and system for secure file sharing and collaboration though link collaboration and granular access control. These techniques enable a file owner to securely and efficiently distribute a portion of a file to one or more collaborators for them to change/adjust/edit the file portion without having access to the entire file. The present techniques include, inter alia, generating and distributing a secure access point to the one or more collaborators to securely access the portion of the file to make edits and/or changes. The present techniques further enable automatic and efficient updating/merging of these changes into the original file when the collaborators have finished changing the file portion through their secure access point. The present techniques thus provide the file owner with granular control over who has access to the file and to how much of the file they have access.

Conventional techniques for file sharing, specifically, sharing a portion or subset of a file, frequently require the file owner to save a copy of the portion of the file to their computing device and use a third-party file sharing service (e.g. email, messaging application, online file hosting service etc.) to transmit the copy to one or more collaborators. When a collaborator receives the copy, they generally must retrieve the copy from the third-party file sharing service, make changes to the copy, and transmit the copy containing changes back to the file owner using a similar third-party file sharing service. The file owner must then retrieve the copy containing changes and edit the original file to incorporate the changes.

Such conventional techniques present major security risks, especially regarding data privacy and security. For example, conventional techniques generally do not allow a file owner to control which portion of a file to share. Instead, the file owner generally must share the entire file. Furthermore, after sharing the file using conventional techniques, the file owner is generally unable to revoke the collaborator's access to view and edit the file once the copy is transmitted, nor is the file owner able to control who the collaborator shares the copy with. Additionally, the file owner may not be able to guarantee the security of any third-party file sharing service.

Moreover, such conventional techniques are inefficient. Continuously transmitting copies of files between the file owner and the one or more collaborators strains network resources, particularly as the number of collaborators increase, the process is performed by numerous file owners and/or when a file owner shares a file more than once. These existing techniques also result in the generation of many file copies, which places significant burdens on computing resources to store and/or otherwise manage these copies, especially when more than one change is made and/or when many collaborators participate in the file editing process. Furthermore, creating, managing, and merging changes of these voluminous file copies utilizing these conventional techniques is generally inefficient and time-consuming.

In contrast, the systems and methods disclosed herein provide solutions to at least these issues experienced by conventional techniques. For example, the present techniques overcome the security limitations and flaws of conventional techniques by generating a secure access point for a file owner to transmit a copy of a portion of a file to be shared. The secure access point may then be distributed to one or more collaborators, where the collaborators can make changes to the copy of the portion of the file via the secure access point. The secure access point thereby resolves the security and privacy issues of existing techniques by only allowing authorized users with permission granted by the file owner to change/adjust/edit the portion of the file. That is, any collaborator must both be authorized and granted permission. As an example, even if the secure access point is distributed to a collaborator without permission to change/adjust/edit the portion of the file, and the collaborator has a user account and is authorized, such collaborator still cannot change/adjust/edit the portion of the file.

In this manner, the file owner may (1) securely transmit files, eliminating security concerns associated with third-party sharing services, (2) curate access only to the file portion, thereby achieving granular control over how much of a file is ever accessible to collaborators, and (3) reliably prevent unauthorized users from accessing the file portion by limiting access to the file portion through the secure access point. Thus, the present techniques improve over the conventional techniques at least by improving the security and privacy of shared data in a way that conventional techniques are not capable of achieving.

Furthermore, the present techniques optimize computing resource usage and network usage, for example, by minimizing extraneous copies of files created during the collaboration process and reducing the frequency that such copies are transmitted via third-party sharing services. In some embodiments, the present techniques require the user to create a secure access point only once, such that each of the collaborators may change/adjust/edit the portion of the file via the same access point. Moreover, after the file owner merges a first set of one or more changes to the portion of the file, the collaborators may further change/adjust/edit the portion of the file via the same access point. Put another way, the file owner may only need to upload the portion of the file once to the secure access point, even when many collaborators make many rounds of changes/adjustments/edits. Therefore, the present techniques eliminate the need for creating copies of a portion of a file each time a file owner shares a copy to a collaborator. Moreover, in scenarios including multiple collaborators and multiple changes made to a file, the present techniques greatly reduce the memory capacity required on a computing device where the file is stored.

Additionally, in some embodiments, the present techniques distribute the secure access point to collaborators using a hyperlink, rather than transmitting a portion of the file. A hyperlink may be easier to encode, as it is typically represented as simple text, requiring less memory than the portion of the file itself. Thus, fewer network packets are required to transmit a hyperlink than a file, resulting in lower utilization of network resources and channels versus conventional techniques. These advantages may be further compounded during collaborative editing, when revisions or updates are made, and these updates need to be made accessible to each collaborator. Instead, collaborators may continue to access the updated portion of the file via the secure hyperlink following each revision/update, avoiding repeated transmission of the portion of the file across the network.

Still further, the present techniques improve the process of merging changes made by collaborators into the original file by allowing the file owner to automatically merge changes made by the collaborators into the original file. Generally speaking, conventional techniques do not offer an efficient and accurate method to merge edits made to a file, especially when multiple collaborators make contrasting edits to the same portion of a file or edits to different portions of the file. In contrast, the present techniques may automatically retrieve one or more portions of the file, each potentially containing multiple contrasting edits from multiple collaborators, and accurately aggregate and incorporate all changes made by the collaborators. Furthermore, the present techniques allow the file owner to preview and modify any edits made to a portion of the file prior to completing the automatic merge, ensuring the accuracy of the merge.

In accordance with the above, and with the disclosure herein, the present disclosure includes improvements in computer functionality or in improvements to other technologies at least because the disclosure describes that, e.g., a computing device (e.g., a user computing device), is improved insofar as the privacy and security of data shared/utilized by the computing device is protected via generating and distributing a secure access point, authorizing users that attempt to access and/or modify the shared data, and denying access to unauthorized access to the secure access point. Additionally, the disclosure describes a novel and efficient method of sharing a copy of a portion of a file to one or more collaborators, and merging changes made by the one or more collaborators to the copy of the portion of the file into the corresponding location in the file, thereby improving the efficiency of the computing device insofar as reducing the computing resources and networking resources required by the computing device when performing sharing and merging operations. That is, the present disclosure describes improvements in the functioning of the computer itself or “any other technology or technical field” because a user computing device is capable of sharing a copy of a portion of a file, securely transmitting the copy of the portion of the file to one or more collaborators, and incorporating changes made by the one or more collaborators into the file more securely and efficiently than was previously achievable with conventional techniques.

Further, the present disclosure includes specific features other than what is well-understood, routine, conventional activity in the field. Additionally or alternatively, the present disclosure includes unconventional steps that demonstrate, in various embodiments, particular useful applications, e.g., generating, by one or more processors, a secure access point for one or more collaborators to change the copy of the portion of the file, and/or distributing, by one or more processors, the secure access point to the one or more collaborators, among others.

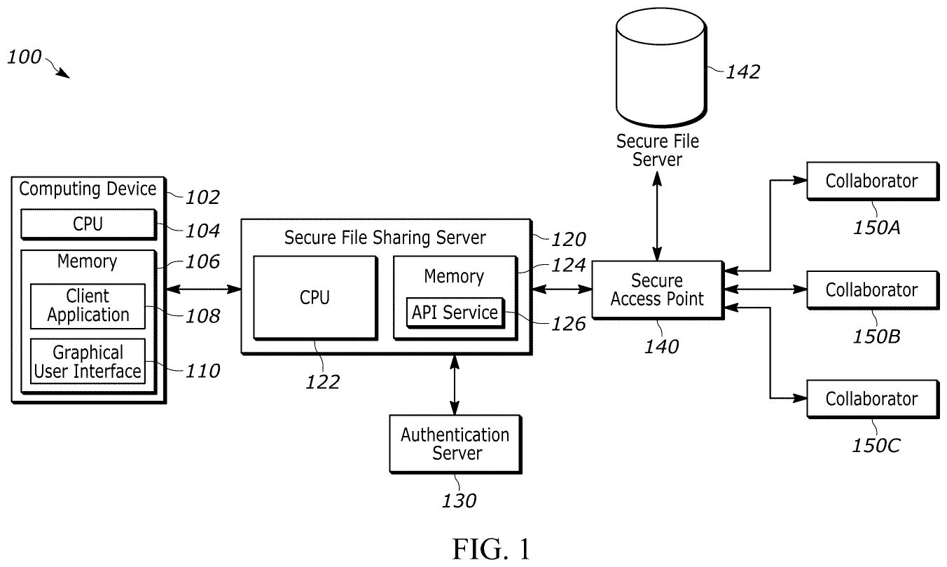

Turning to the Figures, FIG. 1 depicts an example computing environment 100 for implementing various techniques associated with secure file sharing, in accordance with various embodiments described herein. The computing environment 100 includes a computing device 102, a secure file sharing server 120, an authentication server 130, a secure access point 140, a secure file server 142, and collaborators 150A-C. Some embodiments may include a plurality of any of these components illustrated in FIG. 1. Further embodiments may include one collaborator, such as collaborator 150A, or any number of plurality of collaborators.

In some embodiments, the computing device 102 may include a processor 104 which may include one or more central processing units (CPUs), graphics processing units (GPUs), and/or any other suitable processor or controller. The computing device 102 may also include a memory 106 which may be communicatively coupled and/or otherwise access or interact with electronic signals to and from the processor 104, which may include one or more memories and/or forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, etc.

The memory 106 may store machine-readable instructions, such that when the machine-readable instructions are executed by the processor 104, a client application 108 and graphical user interface 110 (GUI) are implemented. The client application 108 may facilitate a user to interact with the computing device 102 when executing methods described herein. The GUI 110 may allow a user to interact with the computing device 102 using an output device (e.g., monitor, television, projector, etc.), and/or an input device (e.g., mouse, keyboard, trackpad, touch screen, eye-tracking device, etc.). In some embodiments, the computing device 102 receives input from a user via the client application 108 and the GUI 110 and may transmit the input to other elements in the computing environment 100.

Generally, the computing environment 100 is configured to facilitate the secure sharing, distribution, and collaboration of a file, or a portion thereof. The computing device 102 may be a device, such as a computer, tablet, or smartphone, belonging to a user, or file owner. The computing device 102 may store a file that the file owner intends to share with one or more collaborators such that the one or more collaborators can change/adjust/edit a portion of the file. The file owner may interact with the GUI 110 to input commands to the client application 108 that securely shares the portion of the file and/or retrieves any edits made to the portion of the file by the one or more collaborators.

In some embodiments, the secure file sharing server 120 may include a processor 122 which may include one or more central processing units (CPUs), graphics processing units (GPUs), and/or any other suitable processor or controller. The secure file sharing server 120 may also include a memory 124 which may be communicatively coupled and/or otherwise access or interact with electronic signals to and from the processor 122, which may include one or more memories and/or forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, etc.

The memory 124 may store machine-readable instructions, such that when the machine-readable instructions are executed by the processor 122, the secure file sharing server 120 may execute an API service 126. Generally, the API service 126 may facilitate communications and data sharing between the computing device 102, the authentication server 130, and the secure access point 140 when executing the methods for secure file sharing as disclosed herein.

The secure file sharing server 120 may receive commands from the client application 108, for example, via the API service 126, to perform the necessary steps to configure the secure access point 140, where the one or more collaborators (150A-C) may change/adjust/edit the portion of the file. For example, the secure file sharing server 120 may communicate with the authentication server 130 to indicate that a collaborator has permission to edit the portion of the file. In some embodiments, a copy of the portion of the file may be stored on the secure file server 142, accessible via the secure access point 140. The secure access point 140 may also communicate with the authentication server 130, for example, via the API service 126, to authenticate and/or validate collaborators that attempt to access the portion of the file.

The authentication server 130 may be any appropriate computing system, such as a server, computing device, database etc., configured to manage user accounts and user authentication. The authentication server 130 may provide services such as user credential verification, session management, and access control enforcement, and may support authentication protocols including, but not limited to, OAuth, OpenID Connect, SAML, and other proprietary authentication mechanisms. The authentication server 130 may be implemented as a cloud-based service, an on-premises appliance, or a hybrid deployment. The authentication server 130 may communicate with client devices, application servers, and third-party services over secure network protocols, such as HTTPS, TLS, or secure WebSockets. In order to enhance security, the authentication server 130 may incorporate encryption, hashing, and other cryptographic techniques to protect user credentials and authentication tokens.

In general, the authentication server 130 may communicate with the computing device 102, the API service 126, the secure access point 140, the secure file server 142, and/or the collaborators 150A-C. In some embodiments, the authentication server 130 manages user credentials and authentication factors. For example, the authentication server 130 may store a record of a set of user credentials. Each credential may be assigned by the authentication server 130, by a third-party, such as a systems or IT manager, or may be created by a user corresponding to the user credential. The authentication server 130 may authenticate a user by verifying that one or more authentication factors provided by the user matches the one or more authentication factors stored in the corresponding user credential.

The authentication server 130 may perform various methods for verifying user identities and controlling access to protected resources. Additionally, the authentication server 130 may contain any appropriate hardware and/or software to perform such methods. In some embodiments, the authentication server 130 may store an identity of, or a record of, a user. In order to authenticate the user, the authentication server 130 may store one or more authentication factors with the identity of the user. Authentication factors may involve password-based verification, multi-factor authentication (MFA), biometric recognition, cryptographic key exchanges, or token-based authentication protocols such as OAuth or SAML. User identities and the corresponding authentication factor(s) may be generated by a user themselves, by a software program, or by a third-party, such as a system administrator. It should be understood that in general, only a user corresponding to the user identity should know the corresponding authentication factor(s), thereby ensuring that only the user can successfully authenticate the corresponding user identity.

The secure access point 140 may be any appropriate secure gateway where the collaborators 150A-C are able to access a copy of a file that a file owner shared with the secure file sharing server 120. In some embodiments, the secure access point 140 may be accessible to the collaborators 150A-C via a network and/or the internet. In further embodiments, the secure access point 140 may be accessed by an address, such as an Internet Protocol (address), a web address, or a file directory address. The address may be a hyperlink (“link”) that points to the address of the secure access point.

In order to improve the efficiency of accessing the copy of the file, the secure access point 140 may “host” a GUI allowing one or more collaborators to access and make changes to the copy of the file via the GUI. Hosting may refer to executing and/or running an application where the machine-readable code is stored remotely, such as in a remote cloud server or web server. In further embodiments, the secure access point 140 may store machine-readable code locally that when executed, runs a GUI.

In some embodiments, the secure file server 142 may be used to store the file to be shared. The secure file server 142 may be a server, a database, or a computing system that is capable of storing and managing files. The secure file server 142 may be hosted on-premises, in a cloud environment, or in a distributed and/or hybrid architecture, enabling scalable and fault-tolerant data management. Access to the secure file server 142 may be controlled through authentication mechanisms, access control policies, and encryption to ensure data privacy and security.

In the context of the present application, the collaborators 150A-C may be referred to in such a way that the collaborator corresponds to an individual user. That is, a collaborator, such as the collaborator 150A, refers to a user that a file owner intends to securely share a file with. It should be understood however, that although not depicted in FIG. 1, a collaborator may also refer to a computing device used by the corresponding user, especially in the context of “accessing” the secure access point 140 by a collaborator. The aforementioned computing device may contain any hardware and/or software components, such as one or more processors and one or more memories to facilitate the user to access the secure access point 140 and make changes to the file. However, depending upon the embodiment, a “collaborator” can refer to one or more users, and there may be any number of collaborators in the computing environment 100.

Although not depicted in FIG. 1, it should be understood that the elements of the computing environment 100 may communicate via any appropriate network. Exemplary networks may include local area network (LAN) or wide area network (WAN). Communication on the exemplary network may be via a wired connection and protocol (e.g., Ethernet) or a wireless connection and protocol (e.g., Wi-Fi, LTE, 5G, etc.). The elements of the computing environment 100 may include hardware and/or software to facilitate communication via any appropriate network.

In some embodiments, elements of the computing environment 100 may be hosted in the cloud, for example on a web server or a cloud computing platform. That is, elements of the computing environment 100 may be implemented on a cloud computing platform, locally, or some combination thereof. In further embodiments, the computing environment 100 may be an on-premises environment, an edge-computing environment, or some combination thereof.

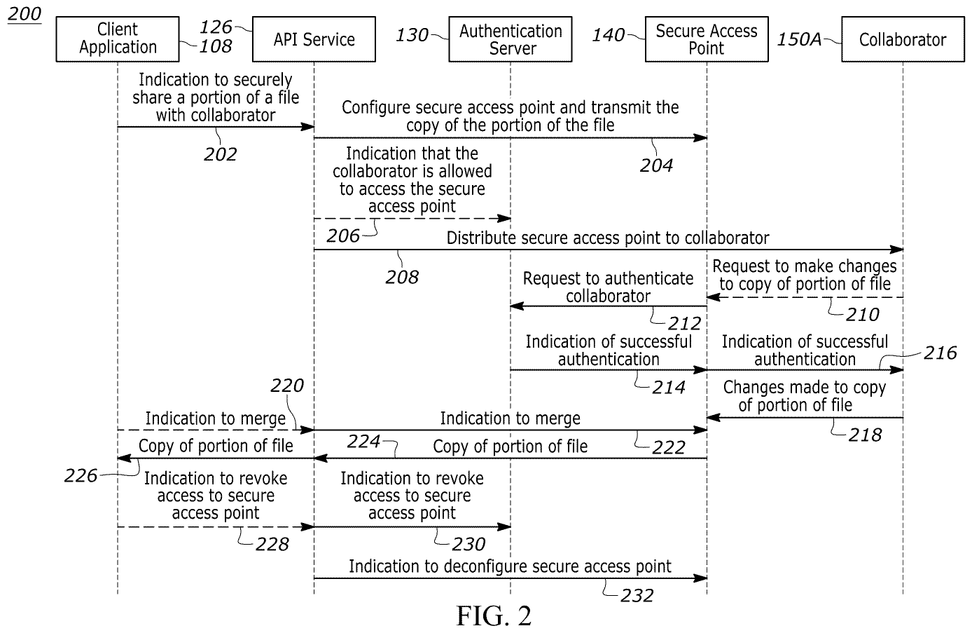

FIG. 2 illustrates an example high-level signal diagram of a method 200 of secure file sharing, in accordance with various embodiments described herein. In some embodiments, the method 200 may include signals and communications transmitted between the client application 108, the API service 126, the authentication server 130, the secure access point 140, and/or a collaborator 150A. It should be understood that, in certain embodiments of the method 200, additional, fewer, or different signals and communications may be transmitted between additional, fewer, or different elements.

The method 200 may generally begin when the client application 108 receives a user input from a file owner via the GUI 110, or via any other appropriate input, indicating that the file owner wants to share a portion of a file with a collaborator, such as collaborator 150A. In response to the user input, the client application 108 may transmit a first indication 202 to securely share a portion of a file to the API service 126. In some embodiments, the first indication 202 may include data such as a key generated by the client application 108 locating the portion of the file within the file, a list of collaborators to share the portion of the file with, and/or any other information regarding access to the portion of the file to be shared.

Upon receiving the first indication 202 from the client application 108, the API service 126 may perform a series of steps to configure a secure method for sharing the portion of the file. In some embodiments, the API service 126 configures the secure access point 140 and transmits a copy of the portion of the file 204 to the secure access point 140. In some embodiments, configuring the secure access point 140 and transmitting the copy of the portion of the file 204 involves storing the copy of the file in a secure location, such as the secure file server 142, and configuring the secure access point 140 as a gateway pointing to the location where the copy of the file is stored. In some embodiments, the secure access point 140 may prohibit access to the location where the copy of the file is stored via other methods other than the secure access point 140. For example, the API service 126 may upload the copy of the file to a secure file hosting Patent Application server and configure the secure access point 140 that directs the collaborator to the copy of the file uploaded to the secure file hosting server.

The API service 126 may also transmit, to the authentication server, an indication 206 that the collaborator 150A is permitted to access the secure access point 140, and correspondingly, make changes to the copy of the file via the secure access point 140. In doing so, the API service 126 may transmit any appropriate identifier that uniquely identifies the collaborator 150A, such as a unique token, user identification (ID) number, name(s) of the user, etc. The API service 126 may transmit whatever identifier is appropriate based upon the credential management method used by the authentication server 130. Subsequently, the authentication server 130 may make any appropriate changes to one or more records inside the authentication server 130 to indicate that the collaborator 150A is authorized to access the secure access point 140.

As depicted by signal 208, the API service 126 may also distribute the secure access point 140 to the collaborator 150A. In general, distributing the secure access point 140 involves transmitting the secure access point 140 via any form of communication to the collaborator 150A. In some embodiments, the secure access point 140 may be accessed via an internet connection through a hyperlink, wherein the API service 126 may email the collaborator 150A and the email body contains the hyperlink. In further embodiments, the secure access point 140 may be accessed via an application or program hosted locally on a computing device, or in the cloud, on a cloud computing server. In yet further embodiments, the secure access point 140 may be accessed directly via an internet protocol (IP) address, or any other appropriate addressing method. Depending upon the access procedure of the secure access point 140, the API service 126 may distribute the secure access point 140 correspondingly.

The method 200 may optionally include the collaborator 150A submitting a request 210 to make changes to the copy of the portion of the file. In some embodiments, the collaborator 150A may access the secure access point 140 after the API service 126 transmits the secure access point 140 to the collaborator 150A. In order to protect the security and privacy of the copy of the portion of the file, the secure access point 140 may require the collaborator 150A to authenticate prior to allowing access to make changes to the copy of the file. In some embodiments, the secure access point 140 may transmit (signal 212) the request 210 to the authentication server 130 to authorize the collaborator 150A. This authentication may include requesting one or more authentication factors from the collaborator 150A, which the collaborator 150A may provide, and the secure access point 140 may transmit to the authentication server 130.

In some embodiments, after the collaborator 150A is successfully authenticated, the authentication server 130 determines whether the collaborator 150A has permission to make changes to the copy of the portion of the file via the secure access point 140. If the authentication server 130 determines that the collaborator 150A does have permission to make changes to the copy of the portion of the file, the authentication server 130 may transmit an indication of a successful authentication 214 to the secure access point 140. The secure access point 140 may then also transmit an indication of successful authentication 216 to the collaborator 150A. In some embodiments, the indication of successful authentication may be a security token granted to a computing device of the collaborator 150A. The secure access point 140 may not allow the computing device of the collaborator 150A to make changes to the copy of the portion of the file if the security token is not detected.

The security token may be stored in the memory of the computing device of the collaborator 150A. The secure access point 140 may scan the memory of the computing device of the collaborator 150A to determine if the security token is present. In some embodiments, the secure access point 140 may require that the computing device of the collaborator 150A store the security token in a predetermined location in the memory of the computing device. That is, the secure access point 140 may check the predetermined location in memory to determine if the security token is present.

For example, the secure access point 140 may detect a security token on a first computing device of a first collaborator and may allow the first collaborator to make changes to the copy of the file. On the other hand, the secure access point 140 may not detect a security token on a second computing device of a second collaborator and may subsequently block the second collaborator from viewing and editing the copy of the portion of the file. In further embodiments, the secure access point 140 may grant different types of security tokens corresponding to different permissions granted to a collaborator by the file owner. For example, the secure access point 140 may grant a security token that allows a first collaborator to make changes to the copy of the portion of the file but may grant a security token to a second collaborator that allows viewing, but not editing, of the copy of the portion of the file.

The authentication server 130 may validate the security token. A security token may be invalid if the security token is expired or if the authentication server 130 detects that the security token may be spoofed or modified. The authentication server 130 may utilize methods such as digital signatures, hashing, public key encryption, checksums and/or any other appropriate cryptographic methods of data integrity validation to determine the integrity of the security token. If no security token is detected, or an invalid security token is detected, the authentication server 130 will not permit the collaborator to view and/or make changes to the copy of the portion of the file. Optionally, the authentication server 130 may request the collaborator to reauthenticate, and after a successful reauthentication, the authentication server 130 may grant a new security token.

Following the successful authentication, the secure access point 140 may grant the collaborator 150A permission to make changes to the copy of the file via the secure access point 140. The collaborator 150A may then optionally transmit data to the secure access point 140 corresponding to changes made to the copy of the portion of the file 218. The secure access point 140 may then save the changes, for example, to the secure file server 142. The secure access point 140 may track any changes made to the copy of the portion of the file. For example, the secure access point 140 may save a record of what changes were made, and which collaborator made such changes. The tracked changes may be stored with or separate from the copy of the portion of the file. In some embodiments, the secure access point 140 may generate a notification at the client application 108 to notify the file owner that the collaborator 150A has made changes to the copy of the portion of the file.

The method 200 may proceed when the client application 108 receives a user input via the GUI 110, or via any other appropriate input, indicating that the file owner wants to merge changes made to the copy of the portion of the file into the original file that does not feature any changes made by collaborators. In response to the user input, the client application 108 may optionally transmit a second indication to merge 220 to the API service 126. In some embodiments, the API service 126 then transmits a similar indication to merge (222) to the secure access point 140. Upon receiving the indication 222, the secure access point 140 may transmit the copy of the portion of the file (signal 224), containing changes made by the collaborator 150A, to the API service 126.

The API service 126 may then transmit (signal 226) the copy of the portion of the file with the changes to the client application 108. In some embodiments, the client application 108 may display on the GUI 110 an indication of what changes were made. The changes may be displayed in such a way so that the file owner can compare the original file with the changes in the copy. In further embodiments, the file owner may be presented options via GUI 110 to either confirm the merge or cancel the merge. If the file owner chooses to confirm the merge, the client application 108 may automatically merge the changes in the copy of the portion of the file into the original file. The client application 108 may locate the portion of the file within the file using the key generated when distributing the portion of the file. In some embodiments, the client application 108 may merge the changes based upon user preferences or selections via the GUI 110. For example, the client application 108 may save two copies of the file, one without the changes, and one with the merged changes.

The method 200 may optionally include the client application 108 transmitting an indication 228 to revoke access to the secure access point 140 (e.g., a third indication). In some embodiments, the client application 108 may transmit the third indication 228 upon receiving a user input from the file owner via GUI 110 indicating that the file owner would like to revoke access to the secure access point 140. In further embodiments, the client application 108 may automatically send the third indication 228 based upon predetermined preferences or rules specified by the user. For example, a rule may state that access to the secure access point 140 is revoked after 48 hours after sharing with a collaborator. The client application 108 may start a timer following the distribution of the secure access point 140 and send the third indication 228 after 48 hours has elapsed on the timer. In some embodiments, the third indication 228 may contain data indicating that access to the secure access point 140 should be revoked for all authorized collaborators. In further embodiments, access may only be revoked for a subset of the group of authorized collaborators.

Regardless of the instructions included as part of the third indication 228, the API service 126 may transmit a subsequent indication 230 to the authentication server 130 to revoke access to the secure access point 140 for the indicated collaborators. The authentication server 130 may then update the one or more records in the authentication server 130 to reflect that the indicated collaborators (e.g., collaborator 150A) no longer have permission to access the secure access point 140. Put another way, subsequent to receiving the indication 230 to revoke access to the secure access point 140, if the collaborator 150A requests to make changes to the copy of the portion of the file via the secure access point 140, the authentication server 130 will transmit a failed authentication to the secure access point 140, thereby preventing the collaborator 150A from making changes to the copy of the portion of the file.

In some embodiments, the third indication 228 may include instructions to deconfigure the secure access point 140. For example, such an instruction might be included in the third indication 228 if the client application 108 indicates that the file owner is permanently revoking access to make changes to the copy of the portion of the file. The API service 126 may thereafter transmit an indication 232 to the secure access point 140 to take the appropriate steps to deconfigure the secure access point 140. In some embodiments, for example, deconfiguring the secure access point 140 may include deleting the copy of the portion of the file from a secure file server (e.g., the secure file server 142) and deactivating the secure access point 140 such that even authenticated users with permission to make changes to the copy of the portion of the file may no longer access the secure access point 140.

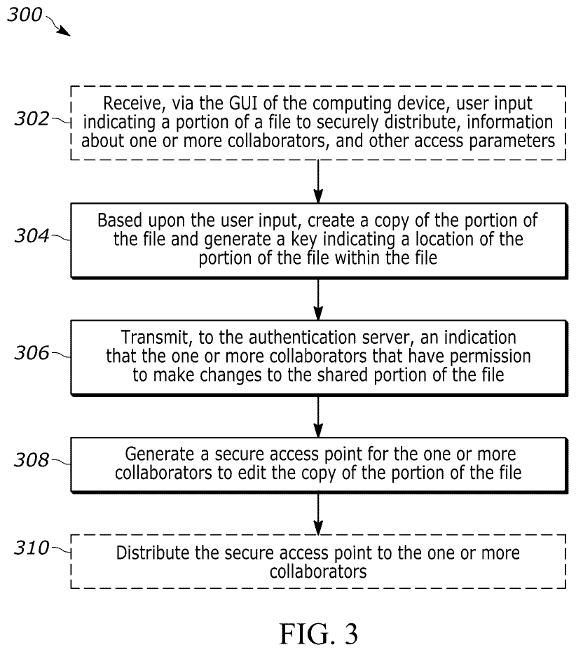

FIG. 3 illustrates an example method 300 of distributing a secure access point for secure file sharing, in accordance with various embodiments described herein. The method 300 may be performed by the computing environment 100 depicted in FIG. 1 and/or any other components as described herein. The method 300 may include additional, alternate, or fewer blocks not depicted in FIG. 3. Similarly, it should be understood that the elements of method 300 may be performed in other orders as appropriate, and that alternate embodiments of the method 300 may similarly change what elements are described as optional herein.

In some embodiments, the method 300 may optionally begin at block 302, where a computing device running an appropriate client application (e.g., the computing device 102 and the client application 108) receives a user input indicating that a user intends to share a portion of the file. The computing device 102 may receive the indication via a graphical user interface of the client application, such as the GUI 110. The user, or “file owner,” may use various input and output devices to interact with the GUI 110. In some embodiments, the client application 108 may present via the GUI 110, a series of buttons and/or menu items to the user. The user may then interact with such buttons and/or menu items to indicate a portion of a file that the user would like to share with one or more collaborators. The user may have the ability, via interacting with the GUI 110, to choose a file stored in the memory 106 of the computing device 102 to share, a portion of the file the user would like to share, one or more collaborators that the user would like to share the portion of the file with, and any other settings related to access parameters for the portion of the file once shared.

Specifically, the user may choose, via the GUI 110, certain parameters to increase the safety and privacy of the shared portion of the file. For example, the user may choose to revoke edit access to the portion of the file after a predetermined amount of time. As another example, the user may require additional authentication steps before allowing the one or more collaborators to make changes to the shared portion of the file, such as requiring two-factor authentication (2FA). As yet another example, the user may choose to make the portion of the file view only, that is, collaborators can only view but not edit the file.

In some embodiments, before sharing the portion of the file, the user may be required to authenticate with the authentication server 130 to verify the identity of the user. For example, when a user is attempting to share a portion of a file via the computing device in a first instance, the authentication server may request the first user to input authentication factors, such as a username and password. After receiving the authentication factors and successfully authenticating the user, the authentication server may transmit a security token to the computing device. In a subsequent second instance, if the user, for example, attempts to change any parameters of the shared file and/or change the collaborators, the authentication server may first attempt locate and verify the security token stored on the computing device. After successfully locating the security token and verifying the validity of the security token, for example, by verifying the security token is not expired, the authentication server may not require the user to re-input authentication factors. In some embodiments, the authentication server 130 may still require the user to input a passkey or a 2FA code, or other similar verification method before the authentication server 130 allows the user to change any parameters of the shared file and/or change the collaborators. Such embodiments improve the privacy and security of any sensitive data over conventional techniques by requiring the user to provide multiple authentication methods, and by ensuring the user is always authenticated before access to any sensitive data is modified.

In some embodiments, the security token may be stored on the computing device 102 in a predetermined location in the memory 106, such that the authentication server 130 and/or the client application 108 can read memory at the predetermined location to determine whether a security token exists. For example, when attempting to share a portion of a file, the authentication server 130 may check the predetermined memory location for a security token. If a security token is detected, the authentication server 130 may proceed to validate the security token. A security token may be invalid if the security token is expired or if the authentication server 130 detects that the security token may be spoofed or modified. The authentication server 130 may utilize methods such as digital signatures, hashing, public key encryption, checksums and/or any other appropriate cryptographic methods of data integrity validation to determine the integrity of the security token. If no security token is detected, or an invalid security token is detected, the authentication server 130 will not permit the user to share a file. Optionally, the authentication server 130 and/or the client application 108 may request the user to reauthenticate, and after a successful reauthentication, grant a new security token.

To protect the security of any sensitive data that may be contained in the file, the authentication server 130 may not allow the user to share the file with any collaborator who is not registered with the authentication server 130. The authentication server 130 may also contain additional rules regarding which collaborators the user may share the file with. For example, the authentication server 130 may only allow a file tagged as highly sensitive to be shared with users that have permission to access highly sensitive data.

In some embodiments, the method 300 may further include creating a copy of the portion of the file and generating a key indicating a location of the portion of the file within the file (block 304). The client application 108 may create a copy of the portion of the file, corresponding to the location within the file that the user indicated to share. Depending upon the user selection, the portion of the file may refer to a subset of pages in the file, a subset of lines of text in the file, and/or any appropriate subsection or combination of subsections of the entire file. It should be understood that in accordance with various embodiments herein, the user may choose to share the entire file. The client application 108 may generate a key, such as a unique alphanumeric sequence, that the client application 108 may use to locate the portion of the file within the file. For example, the generated key may indicate that the user intends to share pages two and three of a document. The format of the key may vary based on the file type of the file, the portion of the file indicated, and/or any other relevant factors related to the file, the user, the client application 108, and/or the computing device 102.

Generally, the client application 108 may use any appropriate software to generate the copy of the portion of the file. For example, if the user indicated to share a line of text in a text file, the client application 108 may use a text editing software to copy the line of text and create a new text file containing only the indicated line of text. It should be understood that this example is only illustrative, and there are many embodiments where portions of various file types may be extracted and/or copied. Alternative file types may include, but are not limited to, documents, spreadsheets, slide decks, and/or images.

The client application 108 may then transmit the copy of the portion of the file and any information regarding the one or more collaborators and/or access control to the API service 126. Prior to transmitting the copy of the portion of the file, the client application 108 may prepare the indicated portion of the file for sharing, for example, by implementing file integrity verification methods, encrypting the copy of the portion of the file, removing any sensitive metadata, and/or any other steps to protect any sensitive data contained in the file. The method 300 may include transmitting, to an authentication server, such as the authentication server 130, an indication that one or more collaborators have permission to make changes to the shared portion of the file (block 306). Namely, the API service 126 may communicate with the authentication server 130 before configuring the secure access point 140 to share the copy of the portion of the file by transmitting a message/indication to the authentication server 130 that the one or more collaborators should have permission to make changes to the copy of the file. After receiving the indication, the authentication server 130 may update any identities and/or records to note that the indicated one or more collaborators should have permission to make changes to the portion of the file. Based upon the specific technical implementations of the authentication server 130, additional or alternative methods may be used to store the indication.

Generally speaking, each of the one or more collaborators may require a preexisting identity or record corresponding to the collaborator in the authentication server 130. If a collaborator of the one or more collaborators does not have an identity, the API service 126 may automatically contact the collaborator and/or a third party to create an identity and one or more authentication factors for the collaborator.

The method 300 may further include generating (e.g., by the API service 126) the secure access point 140 for the one or more collaborators to edit the copy of the portion of the file (block 308). As mentioned, the secure access point 140, in various embodiments, may be a gateway, or a networked system or device that serves as an intermediary between different networks, systems, or applications, facilitating communication and enforcing security or protocol translation. For example, the secure access point 140 may be a website, network application, or any other remotely accessible program that allows collaborators to make changes to the copy of the portion of the file on the secure file server 142. Specifically, generating the secure access point 140 may involve any appropriate and necessary methods to enable the secure access point 140 to facilitate secure communication between the one or more collaborators and the copy of the portion of the file.

In some embodiments, the API service 126 may upload the copy of the portion of the file to the secure file server 142. In further embodiments, the API service 126 may store the copy of the portion of the file in another appropriate storage location, such as a database, a web server, or a memory of a computing device, etc. In yet further embodiments, the copy of the portion of the file may be stored on a cloud storage service. The secure access point 140 may use any appropriate methods to enable the one or more collaborators to access and make changes to the copy of the portion of the file.

The API service 126 may also utilize other security methods to protect the security and privacy of the copy of the portion of the file apart from the user identity management and authentication methods described herein. For example, the API service 126 may use various encryption techniques to encrypt the copy of the portion of the file. A method such as Transport Layer Security (TLS) may be used to encrypt data in transit (e.g., data in transit between elements of the computing environment 100). A method such as AES-256 may be used to encrypt data at-rest (e.g. data stored in the secure file server 142). Such techniques prevent data loss and/or unauthorized even in cases of cybersecurity attacks, such as man-in-the-middle attacks or data breaches.

The API service 126 may also configure the secure access point 140 with any additional security features and/or access control features indicated by the client application 108 and accordingly selected by the user via the GUI 110. As an example, if the user selected an access option for the secure access point 140 to expire after 48 hours, that is, for the secure access point 140 to revoke all access after 48 hours, the API service 126 may configure the secure access point 140 accordingly.

Following the generation and configuration of the secure access point 140, the method 300 may optionally proceed to block 310, where the secure access point 140 is distributed to the one or more collaborators, such as the collaborators 150A-C. As described above, the specific technological implementation of the secure access point 140 may vary depending upon the specific embodiment. For example, if the copy of the portion of the file is stored on a database on a network, the secure access point 140 may be a network port to allow network access to the database, and distributing the secure access point 140 may include generating an IP address, such as by a Dynamic Host Configuration Protocol (DHCP) server, that directs collaborators to the network port.

In some embodiments, the copy of the portion of the file may be uploaded to a secure cloud storage service and/or server. The secure cloud storage service may include a web application that allows collaborators to directly make changes to the files stored on the cloud storage server. In such embodiments the secure access point 140 may be a unique hyperlink that directs collaborators to the application of the secure cloud storage service. A collaborator may follow the hyperlink via the internet, for example, using a web browser, and following successful authentication, may be redirected to the web application enabling the collaborator to make changes to copy of the portion of the file. The API service 126 may distribute access to the secure access point 140 to the one or more collaborators by transmitting the link (e.g. in plain text) in an email body to the one or more collaborators.

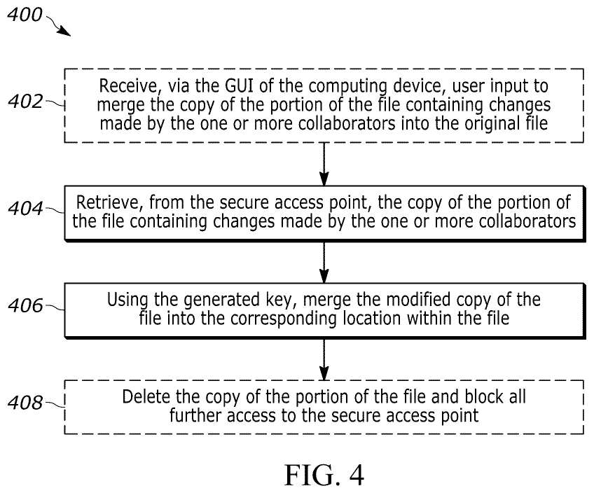

FIG. 4 illustrates an example method 400 of automatically merging changes made to a file, in accordance with various embodiments described herein. The method 400 may be performed by the computing environment 100 depicted in FIG. 1 and/or any other components as described herein. The method 400 may include additional, alternate, or fewer blocks not depicted in FIG. 4. Similarly, it should be understood that the elements of method 400 may be performed in other orders as appropriate, and that alternate embodiments of the method may similarly change what elements are described as optional herein.

The method 400 may optionally include receiving, via a GUI of a computing device, user input to merge the copy of the portion of the file containing changes made by the one or more collaborators into the original file (block 402). The client application 108 may present via the GUI 110 a series of buttons and/or menu items to the user (e.g., a file owner), and the user may interact with such buttons and/or menu items to initiate merging changes to the copy of the file into the original file without changes. Generally, the client application 108, and correspondingly, the GUI 110, may not allow the user to merge until the user has indicated a portion of a file to share and the secure file sharing server 120 has successfully configured the secure access point 140.

The method 400 may further include the client application 108 communicating with the secure file sharing server 120, specifically, the API service 126, to retrieve, via the secure access point 140, the copy of the portion of the file containing one or more changes made by the one or more collaborators (block 404). The client application 108 may transmit an indication, such as a network message, to the API service 126. Upon receipt of the indication, the API service 126 retrieves a copy of the copy of the portion of the file via the secure access point. The API service 126 may retrieve the copy of the portion of the file from the secure access point 140 using any appropriate secure file transfer method. To protect the privacy and security of the copy of the portion of the file, the copy may be encrypted, for example by the secure access point 140. The secure access point 140 may utilize encryption techniques such as public key encryption to ensure that even if the copy of the portion file is intercepted during the transmission, only the intended recipient (e.g. the API service 126 and/or the client application 108) can decrypt, and subsequently view the contents of the copy of the portion of the file. The client application 108 may subsequently receive the copy of the portion of the file from the API service 126.

In some embodiments, and in order to protect the security of the data in the copy of the portion of the file, the client application 108 may require the user to authenticate with the authentication server 130 before allowing the user to merge the copy of the portion of the file with the original file. As previously described regarding block 304 of FIG. 3, the client application 108 may require the user to input one or more authentication factors or redirect the user to the authentication server 130 to directly input the one or more authentication factors. Furthermore, if the security token generated by the authentication server 130 is still detected on the computing device 102, the user may not need to reinput the one or more authentication factors. For example, if the user is attempting to merge changes made to the copy of the portion of the file, but the secure token on the computing device 102 is expired, the authentication server 130 may require the user to reauthenticate to verify the identity of the user and to prevent unauthorized access to the contents of the copy of the portion of the file.

The method 400 may further include using a generated key to merge the modified copy of the portion of the file into the corresponding location within the original file (block 406). Initially, the GUI 110 may enable a user to preview the changes and present the user with an option to confirm the changes before merging. If the user confirms the changes to merge the copy of the portion of the file with the original file, the client application 108 may retrieve a key indicating the location of the portion of the file within the file. For example, this key may be similar/identical to the one generated in block 304 of FIG. 3. The client application 108 may subsequently use the key to locate in the original file the location where the changes indicated in the copy of the portion of the file should be merged into the original file. The client application 108 may proceed to perform the merge in accordance with the merge options selected by the user. Depending upon the file type, the client application 108 may use an appropriate hardware and/or software application to perform the merge. For example, the client application may use an appropriate text editing application to merge a text file.

In some embodiments, the GUI 110 may present the user with additional options and/or selections regarding how the client application 108 should perform the merging procedure. In one embodiment, for example, the user may indicate/instruct the client application 108 to overwrite the original file with changes made by the one or more collaborators. As another example, the user may indicate/instruct the client application 108 to create a new copy of the file with the changes while leaving the original file as is. As yet another example, the user may indicate/instruct the client application 108 to add the changes into the original file without overwriting the original contents of the original file.

In some embodiments, the GUI 110 may present a visual indication to the user of the specific changes and/or edits made by the one or more collaborators. The client application 108 may also “track” the changes in the original file, that is, display via the GUI 110, the original contents of the file side by side with the changes. In further embodiments, the GUI 110 may allow the user to quickly toggle between viewing the original contents and the changes.

In some embodiments, the method 400 may optionally include deleting the copy of the portion of the file accessible via the secure access point 140 and blocking all further access to the secure access point 140 (block 408). In some embodiments, blocking all further access to the secure access point 140 may include the API service 126 sending a request to the secure access point 140 to deconfigure using a similar method as described regarding FIG. 2. Deleting the copy of the portion of the file may prevent further unauthorized access to the copy and improve the security and privacy of the data contained in the copy.

The API service 126 may send a request to the secure access point 140 to delete the copy of the portion of the file after the API service 126 retrieves the copy. Depending upon the embodiment, however, the copy of the portion of the file may be automatically deleted by the secure access point 140 after the copy is retrieved, or the copy may be deleted following a further indication from the user after the merging process is completed. In some embodiments, the user may select an option, via the GUI 110, to automatically delete the copy of the portion of the file after merging. Deleting the copy of the portion of the file may include removing the copy from the corresponding storage location. For example, if the copy of the portion of the file was stored in a secure file server, the deletion step may include removing the copy from the secure file server.

The client application 108 may transmit an indication, or any appropriate communication method to the API service 126 indicating that the copy of the portion of the file should be deleted. The API service 126 may then execute any appropriate steps, such as communicating to the secure access point 140, to delete the copy of the portion of the file.

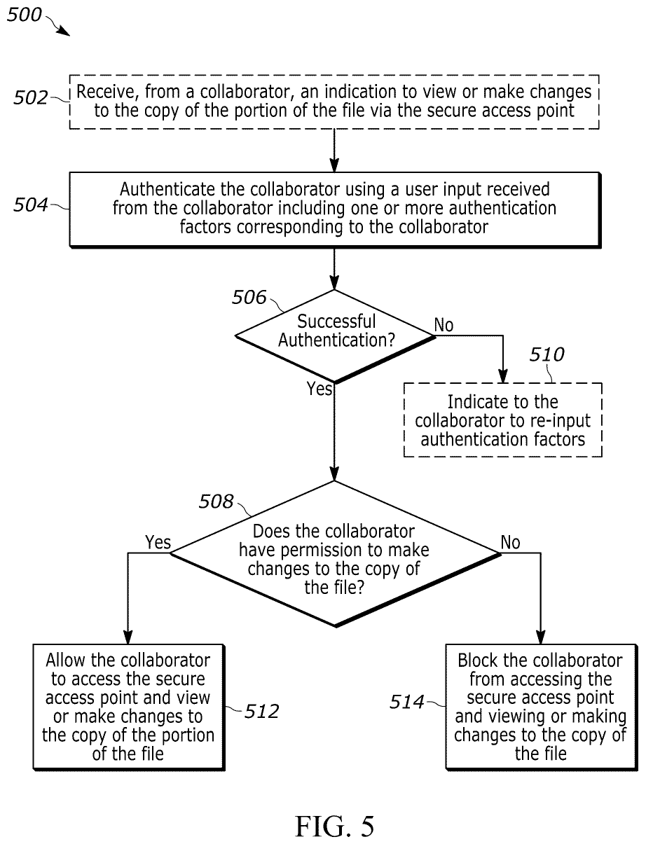

FIG. 5 illustrates an example method 500 for secure collaborator authentication, in accordance with various embodiments described herein. The method 500 may be performed by the computing environment 100 depicted in FIG. 1 or any other components as described herein. The method 500 may include additional, alternate, or fewer blocks not depicted in FIG. 5. Similarly, it should be understood that the elements of the method 500 may be performed in orders as appropriate, and that alternate embodiment of the method 500 may similarly change what elements are described as optional herein.

The method 500 may optionally begin at block 502, where a collaborator attempts to access the secure access point 140 by transmitting an indication to view or make changes to the copy of the portion of the file. Depending upon the specific technical implementation of the secure access point 140, a collaborator may “access” the secure access point 140 using different methods. In general, the secure access point 140 may be accessed via a network using a computing device capable of accessing a webpage, application, or any similar network application that allows the collaborator to make changes to the copy of the portion of the file. In some embodiments, the secure access point 140 may enable the collaborator to make changes to the copy using a graphical user interface (GUI).

As an example, the secure access point 140 may be accessed via a hyperlink. The hyperlink may direct the collaborator to a website and/or webserver hosting a graphical application and/or program that enables the collaborator to make changes to the copy of the portion of the file. In such an example, the copy of the portion of the file may be stored in a secure file server, which may be hosted in the cloud. The secure access point 140 may direct the collaborator to the copy of the portion of the file and/or the application enabling the collaborator to make changes.

The method 500 may further include authenticating the collaborator using a user input received from the collaborator including one or more authentication factors corresponding to the collaborator (block 504). Prior to allowing the collaborator to access the copy of the portion of the file via the secure access point 140, the secure access point 140 may verify the identity of the collaborator and/or determine if the collaborator has permission to access the secure access point 140. In general, the secure access point 140 may use the authentication server 130 to authenticate the collaborator to verify the identity of the collaborator. For example, the secure access point 140 may request the collaborator to input one or more authentication factors to authenticate the collaborator. The one or more authentication factors may include any identifying information, such as name, a username, or an email address etc., secure and unique authentication methods, such as a password, and any other methods of authentication, such as a one-time password (OTP), a passkey, or a two-factor authentication (2FA) code etc. The secure access point 140 may securely transmit the one or more authentication factors received from the collaborator to the authentication server 130. For example, the secure access point 140 may utilize hashing and/or encryption techniques to secure the transmission.

In further embodiments, the secure access point 140 may re-direct the collaborator directly to the authentication server 130. For example, the authentication server 130 may host a webpage or any similar network accessible program that allows the collaborator to directly input one or more authentication factors to the authentication server 130.

Upon receiving the one or more authentication factors, the authentication server 130 may proceed to attempt to authenticate the collaborator (block 506). Generally speaking, the authentication may succeed or fail, and a successful authentication may occur when the one or more authentication factors provided by the collaborator matches exactly the corresponding authentication factors stored in the authentication server 130. If at least one of the one or more authentication factors provided by the collaborator does not match the corresponding authentication factors in the authentication server 130, the authentication may fail.

Following a failed authentication (No branch of block 506), the method 500 may optionally include the authentication server 130 and/or the secure access point 140 requesting that the collaborator re-input the one or more authentication factors (block 510). In addition, the authentication server 130 and/or the secure access point 140 may generate an alert indicating to the collaborator the failed authentication. The alert may include any information regarding the reason the authentication failed. In some embodiments, after the collaborator re-inputs the one or more authentication factors, the method 500 may proceed back to block 504 (not shown).

In some embodiments, after a failed authentication, the authentication server 130 and/or the secure access point 140 may not allow the collaborator to re-input the one or more authentication factors and try to authenticate again. For example, in order to protect the security of the secure access point 140, the authentication server 130 may block any further attempts to authenticate the collaborator after a pre-determined number of failed authentications. As another example, the authentication server 130 may automatically block any further attempts to authenticate the collaborator if the authentication server 130 and/or the secure access point 140 detect any suspicious activity regarding the authentication attempt. If the authentication server 130 has blocked further attempts to authenticate the collaborator, the collaborator may be permanently blocked from accessing the copy of the portion of the file via the secure access point 140.

Following a successful authentication (Yes branch of block 506), the method 500 may further include the authentication server 130 determining whether the collaborator has permission to access the secure access point 140 and make changes to the copy of the portion of the file (block 508). In general, for greater efficiency, the authentication server 130 may only make the determination after the collaborator has been successfully authenticated. For example, the authentication server 130 may identify the collaborator using the one or more authentication factors to identify one or more records corresponding to the collaborator. The authentication server may analyze the one or more records to determine whether the collaborator has permission to access the secure access point 140 and make changes to the copy of the portion of the file. Depending upon the technical implementation of the authentication server 130, however, any appropriate methods to determine whether the collaborator has permission to access the secure access point 140 and make changes to the copy of the portion of the file may be taken.

Following a successful determination that the collaborator has permission to access the secure access point 140 (Yes branch of block 510), the method 500 may further include granting the collaborator access to the secure access point 140 (block 512). In some embodiments, the authentication server may transmit a security token to a computing device of the collaborator. The security token may indicate that the computing device and correspondingly, the collaborator, is authenticated and has permission to make changes to the copy of the file. Furthermore, the secure access point 140 may not allow any computing device to make changes to the copy of the file if a security token is not detected on the device. In some embodiments where the collaborator accesses the secure access point 140 via a web browser, the security token may be a browser cookie.

The collaborator may then proceed to make any changes to the copy of the portion of the file. In some embodiments, and based upon the file type, the secure access point 140 may host an application that allows the collaborator to directly make changes to the copy of the portion of the file. In further embodiments, if the copy of the portion of the file is stored in a file server, such as the secure file serve 142, the secure file server 142 may host a graphical application allowing the collaborator to make changes to the copy of the portion of the file. The secure access point 140 and/or the secure file server 142 may automatically save any changes made.

While the collaborator makes changes via the secure access point 140, the authentication server 130 may continuously authenticate the collaborator. For example, if the collaborator leaves the secure access point 140, such as by closing a web page, the authentication server 130 may require the collaborator to repeat the authentication process. As another example, if the security token is not detected, the authentication server 130 may require the collaborator to repeat the authentication process. As yet another example, the authentication server 130 may periodically require the collaborator to re-input the one or more authentication factors.

Following an unsuccessful determination that the collaborator has permission to access the secure access point 140 (No branch of block 510), the method 500 may further include blocking the user from viewing and/or making changes to the copy of the portion of the file (block 514). In some embodiments, the collaborator may have input the correct one or more authentication factors, such that the authentication server 130 successfully verified the identity of the collaborator. However, the authentication server may determine that the collaborator does not have permission to make changes to the copy of the portion of the file. For example, the file owner may not have indicated that the collaborator is one of the collaborators that should have access to make changes. Consequently, the secure access point 140 may block the user from making changes to the copy of the portion of the file. In some embodiments, the secure access point 140 may also generate an alert notifying the collaborator that they do not have permission to make changes to the copy of the portion of the file.

The secure access point 140 may present an option to the collaborator to request permission to make changes to the copy of the portion of the file. If the collaborator requests access, the secure access point 140 may transmit the request to the API service 126, which may proceed to then transmit the request to the client application 108, and/or contact the file owner via any appropriate communication method.

Depending upon the embodiment, the method 500 may optionally skip the collaborator authentication process and/or the collaborator permission determination process. For example, the file owner may indicate that any collaborator that is able to access the secure access point 140 may have permission to make changes to the copy of the portion of the file. In some embodiments, the authentication server 130 may only allow the user to share files containing non-sensitive and/or non-confidential data without requiring collaborator authentication.

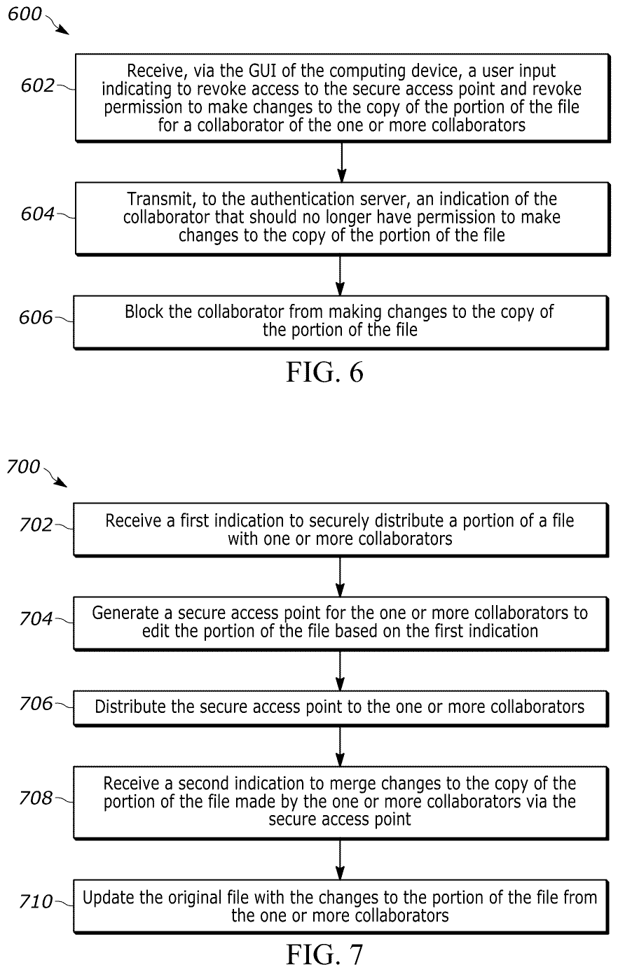

FIG. 6 illustrates an example method 600 of controlling access for a collaborator, in accordance with various embodiments described herein. The method 600 may be performed by the computing environment 100 depicted in FIG. 1 or any other components as described herein. The method 600 may include additional, alternate, or fewer blocks not depicted in FIG. 6. Similarly, it should be understood that the elements of method 600 may be performed in other orders as appropriate, and that alternate embodiments of the method may similarly change what elements are described as optional herein.

The method 600 may include receiving an indication via a GUI to revoke collaborator access to a secure access point and/or revoking collaborator permissions to make changes to the copy of the portion of the file (block 602). In some embodiments, the user may indicate to only revoke access to a first collaborator of the one or more collaborators, while still allowing access for at least a second collaborator of the one or more collaborators.

The GUI 110 may present to the user a list, a table, and/or any appropriate display of information of all the collaborators that have permission to make changes to the copy of the portion of the file via the secure access point. The GUI 110 may present an option to click, select, and/or interact with a name of a collaborator to revoke access for the selected collaborator. The GUI 110 may also present a selection, a button, and/or an option to select all collaborators and/or present a similar option to revoke access for all collaborators that currently have access.

Following a selection from the user, the method 600 may proceed to block 604, where the client application 108 may transmit an indication to the API service 126 to revoke access for the selected collaborators. The API service 126 may transmit an indication to the authentication server 130 that at least one of the one or more collaborators that had permission to make changes to the copy of the portion of the file should no longer be able to make changes to the copy of the portion of the file via the secure access point 140.

The method 600 may then proceed to block 606, where the access to the secure access point 140 is blocked for the selected collaborators. In some embodiments, the authentication server 130 performs a method to update and/or delete any records and/or identities in the authentication server 130 such that when a blocked collaborator of the selected collaborators attempts to access the copy of the portion of the file via the secure access point 140, the authentication server 130 fails the authentication of the blocked collaborator, and the secure access point 140 does not allow the blocked collaborator to view or make changes to the copy of the portion of the file.

In some embodiments, the API service 126 may also transmit an indication, and/or any appropriate communication to notify the secure access point 140 to immediately revoke access for the blocked collaborator. For example, if the blocked collaborator is actively making changes to the copy of the portion of the file, the secure access point 140 may immediately prevent the blocked user from further viewing and making changes, and instead displaying, for example, an error message.

It should be understood that, depending upon the specific technical implementation of the authentication server and/or the secure access point 140, the exact methods to block access to a blocked collaborator may vary, but ultimately, the blocked collaborator may not view or make any further changes to the copy of the portion of the file.

In some embodiments, the GUI 110 may also present a selection, a button, and/or an option to add at least one or more new collaborators to make changes to the copy of the portion of the file. In such embodiments, the client application 108 may transmit an indication to the API service 126 including information about the one or more new collaborators. The API service 126 may transmit an indication to the authentication server 130 indicating that the one or more new collaborators should have access to make changes to the copy of the portion of the file. It should be understood that, based upon the embodiment, the secure access point 140 may be distributed (e.g., by the API service 126) to the one or more new collaborators in a similar or different method than the one or more collaborators.

In certain embodiments, after the API service 126 receives an indication of the one or more new collaborators, the API service 126 may take similar steps as disclosed in FIG. 3 of the present application, including, but not limited to, blocks 302, 306, and 310 of FIG. 3 to ensure the one or more new collaborators are successfully authenticated by the authentication server 130 when attempting to make changes to the copy of the portion of the file via the secure access point 140.

FIG. 7 illustrates an example method 700 for secure file sharing and collaboration, in accordance with various embodiments described herein. The method 700 may be performed by the computing environment 100 depicted in FIG. 1 or any other components as described herein. The method 700 may include additional, alternate, or fewer blocks not depicted in FIG. 7. Similarly, it should be understood that the elements of method 700 may be performed in other orders as appropriate, and that alternate embodiments of the method may similarly change what elements are described as optional herein.

The method 700 may include receiving a first indication to securely distribute a portion of a file with one or more collaborators (block 702). The indication may be transmitted by a user from a computing device, and the indication may identify a location of the portion of the file within the original file, the one or more collaborators to share the portion of the file with, and/or one or more access control parameters. An example access control parameter includes a time limit for how long the one or more collaborators may have access to make changes to the file. In some embodiments, the first indication identifies the one or more collaborators, a location of the portion of the file, and/or a time limit for allowing collaboration.

The method 700 may further include generating a secure access point for the one or more collaborators to change/adjust/edit a copy of the portion of the file via the secure access point (block 704). In some embodiments, generating the secure access point may include generating a key identifying a location of the portion of the file within the file. Subsequently, the method 700 may include extracting the portion of the file from the file based on the location identified by the generated key. The copy of the portion of the file may then be transmitted to the secure access point.

The method 700 may further include distributing the generated secure access point to the one or more collaborators (block 706). In some embodiments, the secure access point may be accessed via a hyperlink, and distributing the secure access point may involve transmitting the hyperlink to the one or more collaborators via email. In further embodiments, the copy of the portion of the file is stored on a secure server such that collaborators can make changes to the copy stored on the secure file server via the secure access point. In some embodiments, the secure file server may be a cloud storage server. In some embodiments, the secure access point may block the one or more collaborators from downloading the copy of the portion of the file.

Additionally, the method 700 may include steps to authenticate a collaborator of the one or more collaborators in response to receiving a request that the collaborator is attempting to make changes to the copy of the file via the secure access point. The authentication method may involve verifying the identity of the collaborator by requesting the collaborator to input one or more authentication factors. An authentication server that stores one or more identities and/or records corresponding to the collaborator may then verify that the inputted authentication factors match the identities and or records of the authentication factor.

In response to a failed authentication, the secure access point may block access to make changes to the copy of the portion of the file for the collaborator. If the authentication succeeds, the authentication server may then proceed to determine whether the collaborator has permission to adjust/edit/change the copy of the portion of the file. If the authentication server determines that the collaborator does not have permission to make changes to the copy of the file (i.e., a failed determination), then the secure access point may block access to view and make changes to the copy of the file for the collaborator, even if the collaborator was authenticated successfully.

In order to further improve the security of the secure access point, the secure access point, in response to a pre-determined number of failed authentications, may generate one or more alerts indicating the failed authentications. The one or more alerts may be transmitted to the collaborator, the file owner, and/or any other third-party that may take actions to protect the security of the copy of the portion of the file, such as a system administrator. The authentication server may also permanently block access to the secure access point for the collaborator in response to the failed authentications. In further embodiments, the authentication server may remove any special permissions corresponding to the collaborator, such as permission to view and make changes to files tagged with sensitive data.

Additionally, based upon the control access parameters selected by the file owner when sharing the portion of the file, the secure access point may revoke access to make changes to the copy of the file after an indicated amount of time by the file owner. In some embodiments, by default, the secure access point may revoke access to make changes to the copy of the portion of the file after a predetermined amount of time.

The method 700 may further include receiving a second indication to merge the copy of the portion of the file containing changes made by the one or more collaborators into to the original file (block 708). The indication may be received from a computing device associated with the file owner.

After receiving the second indication, the method 700 may further include updating the original file with the changes to the portion of the file from the one or more collaborators in response to the second indication (block 710). In some embodiments, the method 700 may retrieve the copy of the portion of the file from the secure access point, or in further embodiments, from the secure file server. The relative location of the portion of the file may be determined using the key generated when the portion of the file was shared, as previously discussed regarding block 704. The copy of the portion of the file may be merged into the original file based on the relative location determined using the generated key. In some embodiments, the merging involves overwriting the portions of the original file with the copy of the portion of the file containing changes made by the one or more collaborators. In some embodiments, the copy of the portion of the file may be deleted from the secure access point subsequent to merging.

The method 700 may additionally or alternatively contain (although not pictured in FIG. 7) steps to block access to at least one collaborator of the one or more collaborators from making changes to the copy of the portion of the file. In some embodiments, the method 700 may receive a third indication to revoke access for a first collaborator of the one or more collaborators to make changes to the copy of the portion of the file. However, a second collaborator of the one or more collaborators may still retain access to make changes to the copy of the portion of the file.

The method 700 may additionally or alternatively contain steps (not shown) to grant access to at least one or more new collaborators to make changes to the copy of the portion of the file. It should be understood that each of the one or more new collaborators may not have already had access to make changes to the copy of the portion of the file. In some embodiments, the method 700 may receive a fourth indication to grant access to at least a new collaborator of the one or more new collaborators to make changes to the copy of the portion of the file. In further embodiments, the method 700 may distribute the secure access point to at least the new collaborator of the one or more new collaborators.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

1. A computer-implemented method for secure file distribution and collaboration, the computer-implemented method comprising:
receiving, by one or more processors, a first indication to securely distribute a portion of a file with one or more collaborators;
responsive to receiving the first indication, generating, by the one or more processors, a secure access point that is a secure gateway instance enabling the one or more collaborators to (i) access a copy of the portion of the file and (ii) change the copy of the portion of the file;
distributing, by the one or more processors, the secure access point to the one or more collaborators;
receiving, by the one or more processors, a second indication to merge one or more changes to the copy of the portion of the file made by at least one of the one or more collaborators through the secure access point; and
updating, by the one or more processors and in response to the second indication, the portion of the file to incorporate the one or more changes made to the copy of the portion of the file.

2. The computer-implemented method of claim 1, wherein generating the secure access point further comprises:
generating, by the one or more processors, a key identifying a location of the portion of the file within the file;
extracting, by the one or more processors, the portion of the file from the file based on the location identified by the generated key; and
transmitting, by the one or more processors, the portion of the file to the secure access point.

3. The computer-implemented method of claim 2, wherein updating the portion of the file to incorporate the one or more changes to the copy of the portion of the file further comprises:
receiving, by the one or more processors, the copy of the portion of the file from the secure access point;
merging, by the one or more processors, the copy of the portion of the file into the file based on the location identified by the generated key; and
deleting, by the one or more processors, the copy of the portion of the file from the secure access point.

4. The computer-implemented method of claim 1, further comprising:
authenticating, by the one or more processors, a collaborator of the one or more collaborators in response to the collaborator attempting to change the copy of the portion of the file through the secure access point; and
blocking, by the one or more processors, access to change the copy of the portion of the file for the collaborator in response to a failed authentication.

5. The computer-implemented method of claim 4, in response to a successful authentication, further comprising:
determining, by the one or more processors, if the collaborator has permission to change the copy of the portion of the file via the secure access point;
transmitting, by the one or more processors, a security token to the collaborator in response to a successful determination wherein the security token is required to change the copy of the portion of the file; and
blocking, by the one or more processors, access to change to the copy of the portion of the file through the secure access point in response to a failed determination.

6. The computer-implemented method of claim 4, further comprising:
in response to a pre-determined number of failed authentication attempts, permanently blocking, by the one or more processors, access to the secure access point for the collaborator.

7. The computer-implemented method of claim 1, further comprising:
blocking, by the one or more processors, access to change the copy of the portion of the file for the one or more collaborators after a predetermined amount of time; or
blocking, by the one or more processors, access to change the copy of the portion of the file for the one or more collaborators after a time limit indicated in the first indication.

8. The computer-implemented method of claim 1, further comprising:
receiving, by the one or more processors, a third indication to revoke permissions to change the copy of the portion of the file for a first collaborator of the one or more collaborators; and
in response to receiving the third indication, blocking, by the one or more processors, access to change the copy of the portion of the file for the first collaborator, wherein a second collaborator of the one or more collaborators maintains access change the copy of the portion of the file.

9. The computer-implemented method of claim 1, further comprising:
receiving, by the one or more processors, a fourth indication to grant permission to change the copy of the portion of the file for at least a new collaborator that is not included in the one or more collaborators; and
in response to receiving the fourth indication:
granting, by the one or more processors, access to change the copy of the portion of the file for the new collaborator; and
distributing, by the one or more processors, the secure access point to the new collaborator.

10. The computer-implemented method of claim 1, wherein the secure access point stores the copy of the portion of the file on a server and wherein the server is a cloud storage server.

11. The computer-implemented method of claim 1, wherein the first indication identifies the one or more collaborators, a location of the portion of the file, and a time limit for allowing collaboration.

12. The computer-implemented method of claim 1, wherein the secure access point is configured to point to a location in a secure file server where the copy of the portion of the file is stored, the secure access point prohibits access to the location via methods other than the secure access point, and the secure access point blocks the one or more collaborators from downloading the copy of the portion of the file.

13. The computer-implemented method of claim 1, wherein the secure access point is accessed via a hyperlink and wherein distributing the secure access point further comprises transmitting the hyperlink to the one or more collaborators via email.

14. A computing system to securely distribute a file for collaboration, the computing system comprising:
one or more processors; and
non-transitory computer memory containing computer-executable instructions that when executed by the one or more processors, cause the computing system to:
receive a first indication to securely distribute a portion of a file with one or more collaborators;
responsive to receiving the first indication, generate a secure access point that is a secure gateway instance enabling the one or more collaborators to (i) access a copy of the portion of the file and (ii) change the copy of the portion of the file;
distribute the secure access point to the one or more collaborators;
receive a second indication to merge one or more changes to the copy of the portion of the file made by at least one of the one or more collaborators through the secure access point; and
update, in response to the second indication, the portion of the file to incorporate the one or more changes made to the copy of the portion of the file.

15. The computing system of claim 14, wherein causing the computing system to generate the secure access point further causes the computing system to:
generate a key identifying a location of the portion of the file relative to the file;
extract the portion of the file from the file based on the location identified by the generated key; and
transmit the portion of the file to the secure access point.

16. The computing system of claim 15, wherein causing the computing system to update the portion of the file to incorporate the one or more changes to the copy of the portion of the file further causes the computing system to:
receive the copy of the portion of the file from the secure access point;
merge the copy of the portion of the file into the file based on the location identified by the generated key; and
delete the copy of the portion of the file from the secure access point.

17. The computing system of claim 14 wherein the non-transitory computer memory contains further computer-executable instructions that when executed by the one or more processors, further cause the computing system to:
authenticate a collaborator of the one or more collaborators in response to the collaborator attempting to change the copy of the portion of the file through the secure access point; and
block access to change the copy of the portion of the file for the collaborator in response to a failed authentication.

18. The computing system of claim 14, wherein the non-transitory computer memory contains further computer-executable instructions that when executed by the one or more processors, further cause the computing system to:
block access to change the copy of the portion of the file for the one or more collaborators after a predetermined amount of time; or
block access to change the copy of the portion of the file for the one or more collaborators after a time limit indicated in the first indication.

19. The computing system of claim 14, wherein the non-transitory computer memory contains further computer-executable instructions that when executed by the one or more processors, further cause the computing system to:
receive a third indication to revoke permission to change the copy of the portion of the file for a first collaborator of the one or more collaborators; and
in response to receiving the third indication, block access to change the copy of the portion of the file for the first collaborator, wherein a second collaborator of the one or more collaborators maintains access to change the copy of the portion of the file.

20. A non-transitory computer-readable medium storing instructions that, when executed by one or more processors, cause the one or more processors to:
receive a first indication to securely distribute a portion of a file with one or more collaborators;
responsive to receiving the first indication, generate a secure access point that is a secure gateway instance enabling the one or more collaborators to (i) access a copy of the portion of the file and (ii) edit the copy of the portion of the file;
distribute the secure access point to the one or more collaborators;
receive a second indication to merge one or more changes to the copy of the portion of the file made by at least one of the one or more collaborators through the secure access point; and
update, in response to the second indication, the portion of the file to incorporate the one or more changes made to the copy of the portion of the file.
